(19) United States
(12) Patent Application Publication
(10) Pub. No.: US 2006/0057446 A1
(43) Pub. Date: Mar. 16, 2006

(54) Control of conductivity reduction within a fuel cell system

(75) Inventor: Hidetaka Nishimura, Yokosuka-shi (JP)

Correspondence Address: SHUMAKER & SIEFFERT, P. A., 8425 SEASONS PARKWAY, SUITE 105, ST. PAUL, MN, 55125, US

(73) Assignee: Nissan Motor Co., Ltd., Yokohama-shi (JP)

(21) Appl. No.: 11/226,103

(22) Filed: Sep. 14, 2005

(30) Foreign Application Priority Data
Sep. 16, 2004 (JP) 2004-269340

(51) Int. Cl. H01M 8/04

(52) U.S. Cl. 429/22; 429/26; 429/24; 429/13

(57) ABSTRACT

A fuel cell system is described that reduces ion elution and extends the life of an ion-exchange resin in a deionization unit of the fuel cell system. Based on a detected value from a conductivity meter and a measured value from a temperature sensor, a controller operates a three-way valve to control the flow rate of coolant passing through the deionization unit in order to regulate a reduction amount of conductivity of the coolant by the deionization unit. The controller controls the flow rate to maintain a relatively high level of conductivity at or within limit values allowed by the fuel cell stack, thereby extending the life of the ion exchange resin of the deionization unit.

This application claims priority under 35 U.S.C. 119 to Japanese Patent Application No. 2004-269340, filed Sep. 16, 2004, the entire disclosure of which is hereby incorporated herein by reference.

### TECHNICAL FIELD

The present invention relates to a fuel cell system equipped with a coolant channel for cooling the fuel cell stack and, more particularly, to control of the coolant conductivity.

### BACKGROUND

A typical fuel cell system is equipped with, for example, a fuel cell comprised of a stack structure with multiple layering of fuel cells (power generation units). By supplying an oxidizer gas, such as air, to an oxidizer electrode and a fuel gas, such as hydrogen, to a fuel electrode of each cell, generated output is obtained by electrochemically reacting oxygen in the air and hydrogen through an electrolyte membrane. There are great expectations for putting this kind of fuel cell system into practical use, for example as a power source for automobiles, and research and development towards practical application is currently thriving.

In a fuel cell system, such as the one described above, some sort of a cooling mechanism is required in order to maintain the correct operating temperature (about 80° C.), because the fuel cell stack generates heat during power generation. A cooling mechanism with a structure that cools the fuel cell by providing a circulatory supply of coolant to the fuel cell stack through a coolant channel that is connected to the fuel stack is common.

In regards to a fuel cell system equipped with a cooling mechanism that provides a circulatory supply of coolant to the fuel cell stack, deterioration of the coolant conductivity becomes a problem. By the process of repeated circulatory supply of the coolant to cool the fuel cell stack, the coolant conductivity gradually increases, because of the elution of metallic ions from each of the parts used in the coolant channel. When the coolant conductivity exceeds a specified value, the conductivity becomes a factor in shortening the life of the fuel stack cell. Also, when the coolant conductivity is high, this may cause a so-called liquid junction, causing the problem of wasteful consumption of generated output.

In order to avoid the problems associated with an increase of coolant conductivity, various fuel cell systems utilize a deionization unit to decrease conductivity within the coolant channel. In particular, the fuel cell systems pass the coolant through the deionization unit when the coolant conductivity is high.

Some systems measure the conductivity of the circulating coolant that is supplied to the fuel cell stack, and accordingly control the flow rate of the coolant to the deionization unit. In other words, the systems attempt to extend the life of the ion-exchange resin of the deionization unit by controlling the flow of the coolant to the deionization unit with the amount depending on the coolant's level of conductivity, and preventing the constant flow of coolant to the deionization unit.

### SUMMARY

The present invention is directed to a fuel cell system that sufficiently reduces the ion elution in the fuel cell system, making possible the extension of the life span of the ion-exchange resin in the deionization unit.

For example, a fuel cell system is described that includes a fuel cell stack, a coolant channel which cools said fuel cell stack, a conductivity detector which detects the conductivity of the coolant flowing in the coolant channel, a conductivity reducer which reduces the coolant conductivity, and a conductivity regulator which regulates the reduction amount of the conductivity by the conductivity reducer. By means of a fuel cell system with a structure such as this, the present invention, regulates the reduction amount of the conductivity by the conductivity reducer, so that the conductivity regulator maintains the conductivity range of the coolant at or below the allowance limit value and at or above the specified value.

In the fuel cell system of the present invention, it is recognized that the higher the level of the coolant's conductivity (given that it is within the range that does not cause harm to the fuel cell stack), then the lower the level of ion elution rate of the fuel cell system to the coolant. Thus, the described fuel cell system maintains the conductivity of the coolant supplied to the fuel cell stack for circulation at the highest level possible at or above a specified value, within the range allowed by the fuel cell stack. Consequently, it is possible to effectively suppress the increase in the coolant conductivity and simultaneously restrain the ion elution from the fuel cell system to a minimum. In the case of using a deionization unit with ion-exchange resin as a conductivity reducer, this results in extension of the life of the ion-exchange resin of the deionization unit.

In one embodiment, a fuel cell system comprises a fuel cell stack, a conductivity meter that detects a conductivity of a coolant that cools the fuel cell stack, and a conductivity reducer that reduces the conductivity of the coolant. The fuel system further includes a valve to control the flow of the coolant into the conductivity reducer, wherein the valve can prevent the flow of the coolant through the conductivity reducer. The conductivity controller regulates the amount the conductivity is reduced by adjusting the valve.

In another embodiment, a method comprises detecting a conductivity of a coolant for a fuel cell stack, and adjusting a valve to control the flow of the coolant through a conductivity reducer and maintain the conductivity within a conductivity range at or above a specified value and at or below an allowance limit value of the fuel cell stack.

In another embodiment, a fuel cell system comprises a fuel cell stack, means for detecting a conductivity of a coolant that that cools the fuel cell stack, means for reducing the conductivity of the coolant, means for adjusting the flow of the coolant through the reducing means, and means for controlling the conductivity of the coolant within a range selected to have a reduced conductivity-time gradient by controlling the conductivity of the coolant within a range selected to have a reduced conductivity-time gradient by controlling the adjusting means to block the flow of the coolant.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram that shows an example embodiment of a fuel cell system in accordance with the principles of the invention.

FIG. 2 is a graph that shows a change of coolant conductivity as time elapses.

FIG. 3 is a graph that shows the relationship between coolant conductivity and an ion elution rate.

FIG. 4 is a graph that shows, for a case of setting the target conductivity at a low conductivity, the changes in coolant conductivity against elapsed time, and the ion reduction amount by the deionization unit.

FIG. 5 is a graph that shows, for a case of setting the target conductivity at a high conductivity, the changes in coolant conductivity against elapsed time, and the ion reduction amount by the deionization unit.

FIG. 6 is a graph that shows, for a case of changing the target conductivity according to the temperature change, the changes in coolant conductivity against elapsed time, and the ion reduction amount by the deionization unit.

### DETAILED DESCRIPTION

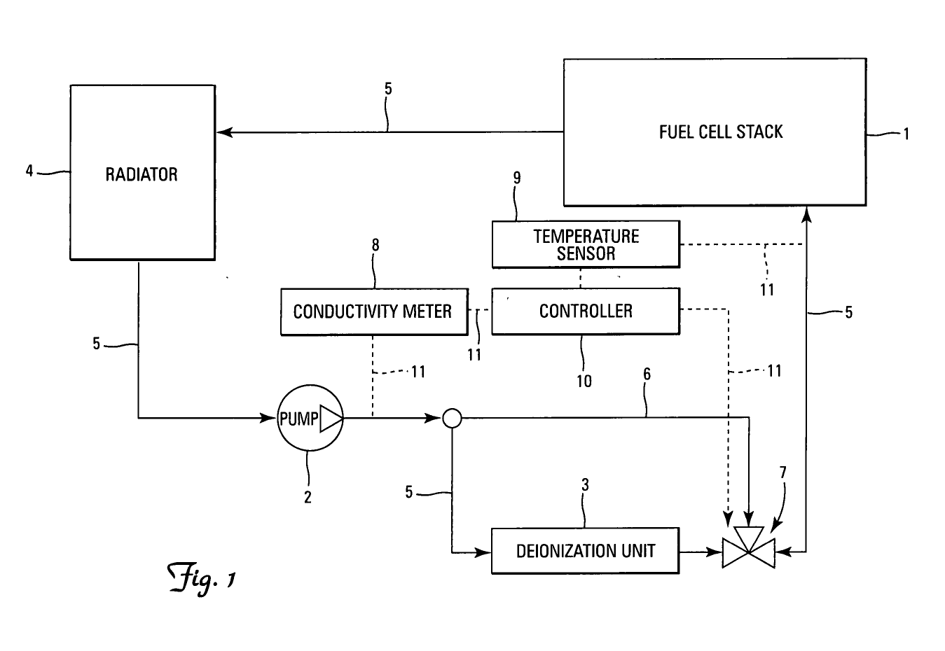

FIG. 1 shows an example of the composition of a fuel cell system with the application of the present invention. Primarily, in FIG. 1, the composition of a cooling system by coolant alone is illustrated, and illustrations of other compositions are omitted. However, for example, the publicly-known structures of a hydrogen supply system and an air supply system are both acceptable for use in this kind of fuel cell.

The exemplary embodiment of the fuel cell system is comprised of a fuel cell stack 1 that generates electricity by the supply of a fuel gas (such as hydrogen) and an oxidizer gas (such as air), and also of a cooling system that provides a circulatory supply of coolant into fuel cell stack 1 for cooling purposes. The cooling system is comprised of a pump 2 that supplies coolant to the fuel cell stack 1, a deionization unit 3 that eliminates the ions dissolved in the coolant, and a radiator 4 that regulates the temperature of the coolant.

Each of the following parts is connected by coolant lines 5: the cooling pump 2 and the deionization unit 3, the deionization unit 3 and the fuel cell stack 1, the fuel cell stack 1 and the radiator 4, and the radiator 4 and the pump 2. Also, between the pump 2 and the fuel cell stack 1, a bypass line 6 is provided that bypasses the deionization unit 3, and a three-way valve 7 is provided at the meeting point of bypass line 6 and the coolant line 5, which is the latter part of the deionization unit 3.

Also, in one embodiment of the fuel cell system, the cooling system is equipped with a conductivity meter 8 that detects the conductivity of the coolant flowing in the coolant lines 5, a temperature sensor 9 that measures the temperature of the coolant, and a controller 10 that controls the flow rate of the coolant passing through the deionization unit 3 by operating the three-way valve 7, based on the detected value from the conductivity meter 8 and measured value from the temperature sensor 9. Each of these mentioned above, the controller 10, the conductivity meter 8, the temperature sensor 9, and the three-way valve 7, are connected to each other by control lines 11.

In the example embodiment of the fuel cell system as described above, the coolant lines 5 correspond to the coolant channel, the conductivity meter 8 corresponds to a conductivity detection means, and the deionization unit 3 corresponds to a conductivity reducer. Also, in this fuel cell system, the controller 10 operates the three-way valve 7 based on the coolant conductivity detected by the conductivity meter 8 and the coolant temperature measured by the temperature sensor 9, and controls the flow rate of coolant passing through the deionization unit 3.

In one embodiment, controller 10 regulates the reduction amount of conductivity by the deionization unit 3 so that the conductivity of the circulating coolant that is supplied by the cooling system to the fuel cell stack 1 is maintained within the conductivity range, at or under the allowance limit value for the fuel cell stack 1 and at or above a specified value. In some instances, controller 10 may adjust the valve 7 to completely prevent flow of the coolant through the deionization unit 3, thereby maintaining the conductivity above the specified value and below the allowance limit. In some embodiments, the allowance limit value may be set based on a safety factor offset from a permissible limit for the fuel cell stack 1. A specific description of the conductivity control of the coolant, which is characteristic to this fuel cell system in this example embodiment, is described below.

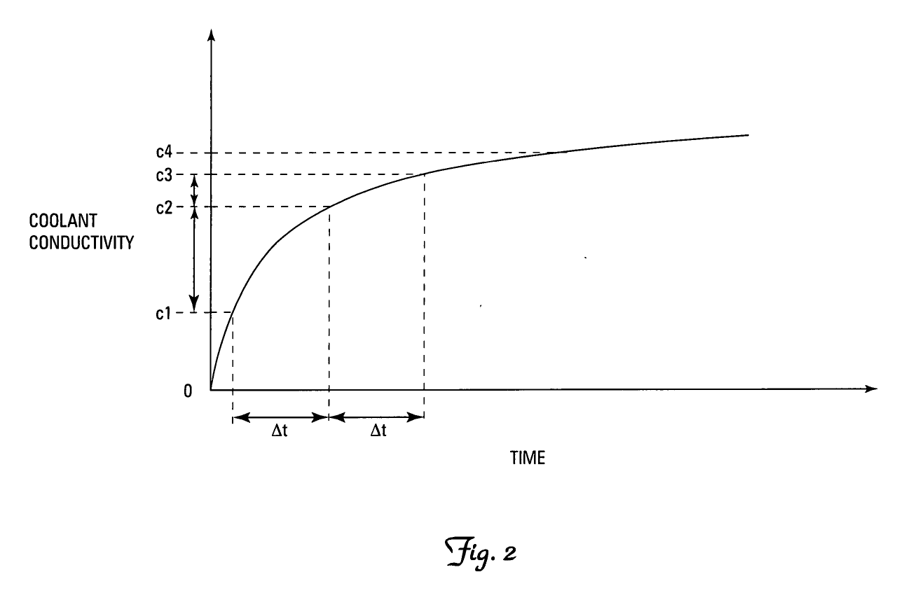

FIG. 2 is a curve plot diagram, which shows the change of conductivity of the coolant as time elapses. As shown in FIG. 2, at a steady temperature, the conductivity of the coolant flowing in the coolant lines 5 increases as time elapses. However, even with the same amount of elapsed time Δt, when comparing the increase from conductivity c1 to conductivity c2, and the increase from conductivity c2 to conductivity c3, the latter is smaller.

This means that by maintaining the coolant conductivity at a certain high level, the increase in conductivity, in another words, the elution of ions into the coolant, can be suppressed. Therefore, the example embodiment of the fuel cell system regulates the reduction amount of conductivity by the deionization unit 3, within the range of the allowable conductivity (allowance limit value) c4 or lower for the fuel cell stack 1. As a result, the conductivity has a smaller gradient than the gradient at the time of low conductivity when the gradient of time change of the conductivity reaches a maximum. For this reason, controller 10 maintains the coolant conductivity at a relatively high level where the gradient is smaller. The allowable limit conductivity c4 for the fuel cell stack 1 can be determined by the insulation resistance of the fuel cell system or the corrosiveness of each of the parts where coolant flows.

In the example embodiment of the fuel cell system, it is possible to reduce the ion elution amount from the fuel cell system that must be eliminated in the deionization unit 3, and extend the life span of the ion-exchange resin in the deionization unit 3 by using the controls mentioned above. In general, the “life span” of the ion-exchange resin refers to the period during which the total ion-exchange equivalent of the ion-exchange resin is used up by absorbing ions from the coolant.

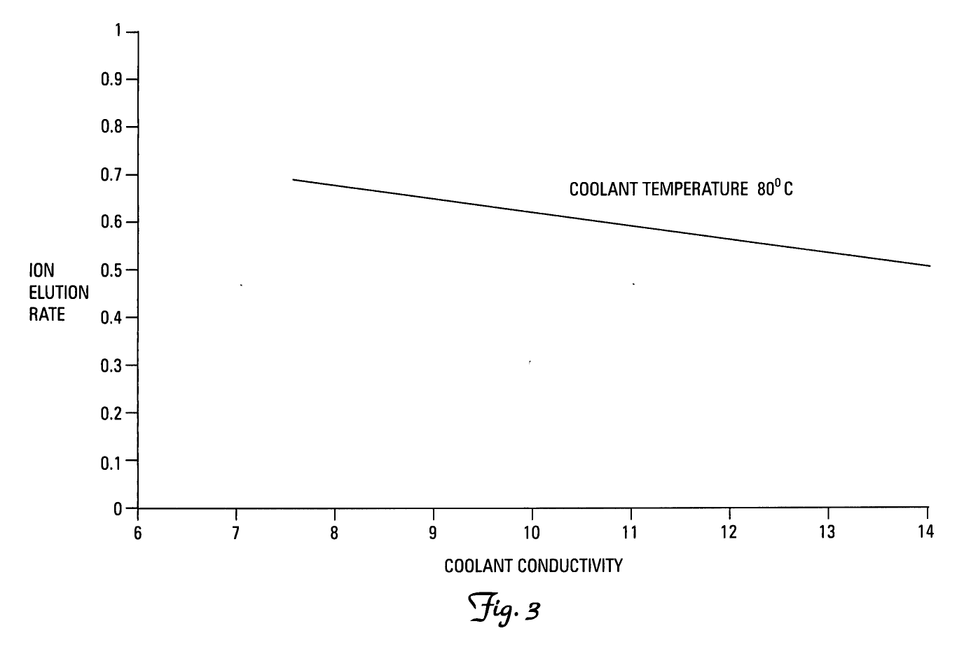

To confirm the effectiveness of the present invention, a case using the conventional control techniques of maintaining a low coolant conductivity and a case using the control technique of the present invention of maintaining a relatively high conductivity were performed. The life span of the ion-exchange resin in the deionization unit 3 for each case was compared. During the tests, the coolant temperature was to be maintained at a steady 80° C. and the fuel cell system was structured so that the relationship of the ion elution rate would be similar to the one in FIG. 3.

In addition, the deionization unit 3 was given the capability to reduce only 50% of the coolant conductivity flowing into the deionization unit 3, and the ion equivalent per unit conductivity in the coolant was set to 1 meq/(μS/cm), the ion equivalent that can be eliminated by the ion-exchange resin in the deionization unit 3 was set to 100 meq, the allowable conductivity determined by the insulation resistance of the fuel cell system was set to 15 μS/cm, and the duration of the coolant circulating once in the cooling system of the fuel cell system was set to 1 minute.

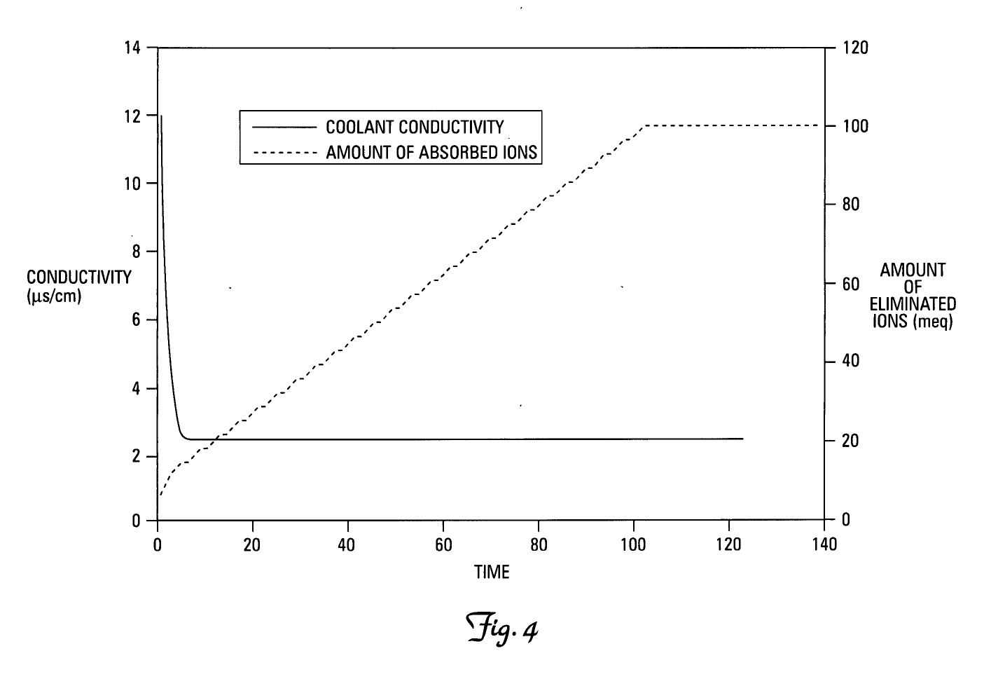

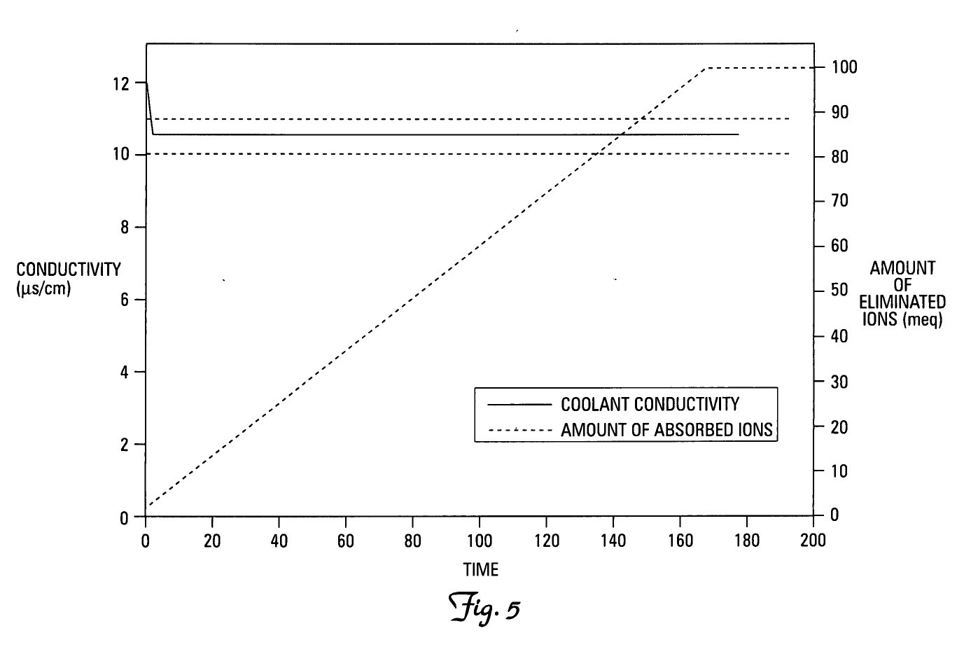

FIG. 4 is an example in which the coolant conductivity was controlled within the range of 2˜3 μS/cm, and shows the changes in coolant conductivity against the elapsed time and the eliminated ion equivalent in the deionization unit. Also, FIG. 5 is an example in which the coolant conductivity was controlled within the range of 10˜11 μS/cm, and shows the changes in coolant conductivity against the elapsed time and the eliminated ion equivalent in the deionization unit.

As shown in FIG. 4, in the example in which the conductivity was maintained at a low level, the life span of the ion-exchange resin in the deionization unit 3 was 100 minutes. On the other hand, as shown in FIG. 5, in the example in which the conductivity was maintained at a high level, the life span of the ion-exchange resin in the deionization unit 3 is 170 minutes, indicating that the life span was extended by as much as 1.7 times the life span of the former.

The above was explained under the condition that the coolant temperature was at a steady 80° C. However, the actual coolant temperature is subject to change according to the operating conditions. In the case where the coolant temperature changes, in order to more effectively extend the life of the ion-exchange resin as stated above, it may be preferable to set the target conductivity at a low level while the coolant temperature is high, and set the target conductivity at a high level while the coolant temperature is low. This is because the lower the temperature, the higher the allowed conductivity, generally.

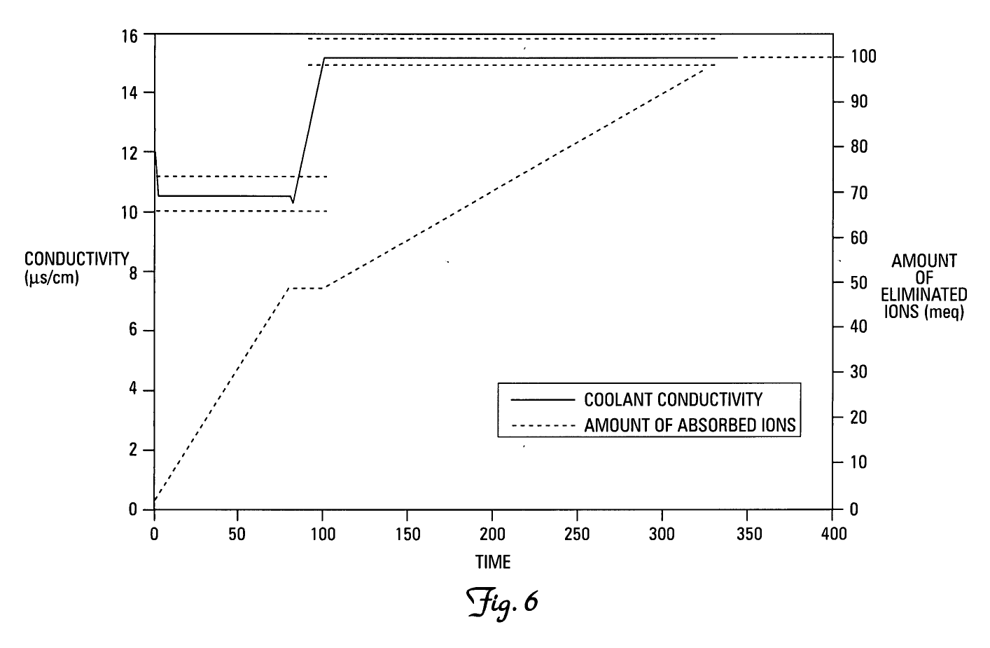

FIG. 6 shows an example of controlling the conductivity according to the temperature of the coolant. This example started at the condition as in FIG. 5. After 80 minutes, the coolant temperature changed from 80° C. to 30° C. and the allowable conductivity became 15 μS/cm from 17 μS/cm; in response to this, it was controlled to make the target conductivity 15˜16 μS/cm.

FIG. 6 shows the changes in coolant conductivity against the elapsed time, and the eliminated ion equivalent in the deionization unit for this case. As shown in FIG. 6, by increasing the target conductivity in response to the drop in coolant temperature from 80° C. to 30° C., it is possible to decrease the ion elution rate even more, as well as further extend the life span of ion-exchange resin in the deionization unit 3.

In the described fuel cell system, the reduction amount of the conductivity by the deionization unit 3 is regulated by controlling valve 7. Valve 7 may, for example, be closed to block coolant from flowing through deionization unit 3 and completely blocking deionization unit 3 from coolant line 5 in order to maintain a relatively high level (that is within the range of at or under the allowable limit value accepted by the fuel cell stack 1) of conductivity of the circulating coolant that is supplied to the fuel cell stack 1 by the cooling system. Therefore, it is possible to effectively suppress the increase in coolant conductivity while keeping the ion elution from the fuel cell system to coolant at a minimum, and to extend the life span of the ion-exchange resin in the deionization unit 3. Also, at this time, by setting the coolant conductivity in the range that will not cause leakage of electricity or influence the corrosion of parts, it is possible to operate safely and extend the life of each part that comprises the fuel cell system.

Moreover, when the temperature of the coolant is low, the target conductivity is set high to decrease the reduction amount of conductivity by the deionization unit 3, and when the temperature of coolant is high, the target conductivity is set low to increase the reduction amount of conductivity by the deionization unit 3. This extends the life span of the ion-exchange resin in the deionization unit 3, by suppressing the ion elution in the most suitable condition according to the temperature requirement of the coolant.

Various embodiments of the invention have been described. These and other embodiments are within the scope of the following claims.

1. A fuel cell system comprising:
a fuel cell stack;
a conductivity meter that detects a conductivity of a coolant that cools the fuel cell stack;
a conductivity reducer that reduces the conductivity of the coolant;
a valve to control the flow of the coolant into the conductivity reducer, wherein the valve can prevent the flow of the coolant through the conductivity reducer; and
a conductivity controller that regulates the amount the conductivity is reduced by adjusting the valve.

2. The fuel cell system of claim 1, wherein the conductivity controller adjusts the valve to maintain the conductivity of the coolant within a conductivity range at or above a specified value and at or below an allowance limit value of the fuel cell stack.

3. The fuel cell system of claim 2, wherein the allowance limit value is set based on a safety factor from a permissible limit value associated with the fuel cell stack.

4. The fuel cell system of claim 2, wherein the specified value is set to reduce a gradient for a conductivity change over time for the coolant.

5. The fuel cell system of claim 1, further comprising a temperature sensor coupled to the controller to measure the temperature of the coolant,
wherein the conductivity controller regulates the amount of conductivity reduced by the conductivity reducer based on the measured temperature.

6. The fuel cell system of claim 5, wherein the controller decreases the amount of the conductivity reduced by the conductivity reducer as the temperature of the coolant decreases.

7. The fuel cell system of claim 1, wherein the conductivity reducer is a deionization unit that eliminates dissolved ions in the coolant.

8. The fuel cell system of claim 1, wherein the controller regulates the amount of conductivity reduced by the conductivity reducer by regulating a flow rate of the coolant that is distributed to the deionization unit.

9. The fuel cell system of claim 1, wherein the allowance limit value is set based on a corrosiveness of each of a set of parts that the coolant flows through or the insulation resistance of the fuel cell system.

10. The fuel cell system of claim 1, wherein the allowance limit value is set based on an insulation resistance of the fuel cell system.

11. A method comprising:
detecting a conductivity of a coolant for a fuel cell stack; and
adjusting a valve to control the flow of the coolant through a conductivity reducer and maintain the conductivity within a conductivity range at or above a specified value and at or below an allowance limit value of the fuel cell stack.

12. The method of claim 11, wherein adjusting a valve comprises closing the valve to block the flow of the coolant through the conductivity reducer to maintain the conductivity above the specified value.

13. The method of claim 11, further comprising selecting the allowance limit based on a safety factor from a permissible limit associated with the fuel cell stack.

14. The method of claim 11, further comprising selecting the specified value to reduce a gradient for a conductivity change over time for the coolant.

15. The method of claim 11, further comprising:
measuring the temperature of the coolant; and
controlling the amount of conductivity based on the measured temperature.

16. The method of claim 15, further comprising decreasing the amount of the conductivity reduced by the conductivity reducer as the temperature of the coolant decreases.

17. The method of claim 11, wherein controlling the conductivity comprises reducing the conductivity by eliminating dissolved ions in the coolant.

18. The method of claim 11, further comprising setting the allowance limit value based on a corrosiveness of each of a set of parts through which the coolant flows.

19. The method of claim 11, further comprising setting the allowance limit value based on an insulation resistance of the fuel cell system.

20. A fuel cell system comprising:
a fuel cell stack;
means for detecting a conductivity of a coolant that that cools the fuel cell stack;
means for reducing the conductivity of the coolant;
means for adjusting the flow of the coolant through the reducing means; and
means for controlling the conductivity of the coolant within a range selected to have a reduced conductivity-time gradient by controlling the adjusting means to block the flow of the coolant.
